(19) United States
(12) Patent Application Publication
(10) Pub. No.: US 2015/0314221 A1
(43) Pub. Date: Nov. 5, 2015

(54) CLEANING SYSTEM FOR SAND FILTRATION LAYER

(71) Applicants: HITACHI ZOSEN CORPORATION, Osaka-shi, Osaka (JP); NAGAOKA INTERNATIONAL CORPORATION, Kaizuka-shi, Osaka (JP)

(72) Inventors: Masaki INUI, Osaka (JP); Hideyuki NIIZATO, Osaka (JP); Takayuki INOUE, Osaka (JP); Youichi YANAGIMOTO, Osaka (JP); Tadao OIWA, Osaka (JP); Hitoshi MIMURA, Osaka (JP)

(21) Appl. No.: 14/651,509

(22) PCT Filed: Oct. 25, 2013
(86) PCT No.: PCT/JP2013/078977

§ 371 Date: Jun. 11, 2015

(30) Foreign Application Priority Data
Dec. 14, 2012 (JP) 2012-273514

(51) Int. Cl. B01D 24/46

(52) U.S. Cl. CPC B01D 24/4631; B01D 24/4636

(57) ABSTRACT

To reduce the size, scale of construction, and running cost of an apparatus for cleaning a sand filtration layer. A cleaning system which removes clogging sediments from a sand filtration layer 2, used with an apparatus for an infiltration intake of seawater which performs a seawater intake, by means of a water intake pipe 4 buried in the supporting gravel layer 3, after the seawater has been infiltrated through the sand filtration layer 2 and a supporting gravel layer 3 on an ocean floor. This cleaning system is provided with a diffuser pipe 7 having blow holes 6, and which is buried in the supporting gravel layer 3, as well as a compressed air delivery device 8 for feeding an air into the diffuser pipe 7. The system operates by blowing the air from the blow holes 6 to agitate the filtration sand of the sand filtration layer 2, to remove the sediments which have become trapped in or accumulated on the sand filtration layer 2. The system can achieve a smaller size, a smaller scale of construction, and a lower running cost than a conventional system which injects fresh water or seawater into the sand filtration layer.

### TECHNICAL FIELD

The present invention relates to a cleaning system for a sand filtration layer, configured to remove sediments which cause clogging in the sand filtration layer of a seawater infiltration intake device which is installed on an ocean floor.

### BACKGROUND ART

For example, in seawater desalination plants, a supporting gravel layer and a sand filtration layer are disposed on an ocean floor, and an apparatus for an infiltration intake of seawater is employed to perform seawater intake by means of a water intake pipe buried in the supporting gravel layer after the seawater has infiltrated through these layers, in order to obtain clean seawater with fewer contaminates (e.g., FIG. 1 in Patent Reference 1).

As the intake of seawater continues when the infiltration intake of seawater is implemented using this apparatus for infiltration intake of seawater, sediments such as silt and plankton (referred to below simply as “sediments”) which cause clogging of the sand filtration layer and accumulate on the surface of the sand filtration layer, become trapped inside the sand filtration layer. As a result, voids inside the sand filtration layer gradually become clogged by these sediments. Moreover, as the voids become clogged, if the resulting increased loss of pressure remains untreated, the sand filtration layer becomes completely blocked, ultimately making the intake of water no longer possible. Thus, when employing a water infiltration intake method implemented by using an apparatus for infiltration intake of seawater, it is necessary to perform periodic cleaning, to remove the sediments from the sand filtration layer.

In the past, an apparatus for an infiltration intake of seawater employed a reverse cleaning method which involved an agitation of the sand by injecting fresh water or salt water into the sand filtration layer, and this was likewise employed in a typical sand filtration apparatus.

However, in cases where an apparatus for the infiltration intake of seawater is to cover a large area for the intake of water, the volume of fresh water or sea water required for cleaning increases according to the surface area for the intake of water. Thus, the size of the cleaning apparatus is increased, the scale of construction increases, and the running cost also increases.

### PATENT REFERENCE

Patent Reference 1: Japanese Patent Application Kokai Publication No. 2004-33993

### SUMMARY OF THE INVENTION

### Problems to be Solved by the Invention

The problem which the present invention aims to solve is that the conventional cleaning system for a sand filtration layer was of a type in which fresh water or sea water was injected into the sand filtration layer, and thus required a cleaning apparatus of increased size, a greater scale of construction, as well as increased running cost.

### Means for Solving these Problems

The object of the present invention is to provide a cleaning system for a sand filtration layer, employing a smaller apparatus, having a lower cost, and exhibiting better cleaning capacity than the conventional system which injects fresh water or sea water into a sand filtration layer.

In order to achieve this object, the present invention provides a cleaning system configured to remove clogging sediments from a sand filtration layer. This system is used with an apparatus for an infiltration intake of seawater which performs a seawater intake, by means of a water intake pipe buried in the supporting gravel layer, after the seawater has been infiltrated through the sand filtration layer and the supporting gravel layer on an ocean floor. This cleaning system is provided with a diffuser pipe buried in the supporting gravel layer, the diffuser pipe having blow holes, and a compressed air delivery device configured to feed an air into the diffuser pipe. The air is blown from the blow holes to agitate the filtration sand of the sand filtration layer, to remove the sediments which have become trapped in or accumulated on the sand filtration layer.

According to the present invention, highly pressurized air is blown from the blow holes provided in the diffuser pipe, by feeding the air from the from the compressed air delivery device into the diffuser pipe buried in the sand filtration layer. Bubbles of the highly pressurized air blown from the blow holes cause the filtration sand to be agitated, making it possible to remove the sediments which are trapped in or accumulated on the sand filtration layer.

### Advantageous Effects of the Invention

The present invention uses compressed air as a fluid which operates on the filtration sand, thus making it possible to reduce the size of the apparatus in comparison to conventional systems which inject fresh water or sea water into the sand filtration layer, thereby reducing the scale of construction as well as running cost. The present invention is also able to reliably prevent clogging of the sand filtration layer by regularly feeding air from the compressed air delivery device into the diffuser pipe.

### BRIEF DESCRIPTION OF THE DRAWINGS

FIG. 1 is a drawing illustrating the structure of the cleaning system according to the present invention.

FIG. 2 shows transverse sectional views of the diffuser pipe, where FIG. 2(a) is a drawing illustrating the range of positions of blow holes for which filtration sand does not readily flow in, and FIG. 2(b) is a drawing showing the position of blow holes in the example of FIG. 1.

FIG. 3 shows examples which avoid interference of the blow holes, where FIG. 3(a) is a drawing showing a structure in which the blow holes are disposed in a staggered configuration which alternates between right and left, and FIG. 3(b) is a drawing showing a structure in which the blow holes are arranged in the same positions on the right and left, and disposed so that the blow holes of one diffuser pipe are in a staggered position vis-à-vis the blow holes of a neighboring diffuser pipe.

FIG. 4 shows an example in which the blow holes are shaped to form a nozzle, where FIG. 4(a) is a drawing of a case in which the blow hole has a configuration in which the peripheral area is pushed out; FIG. 4(b) is a drawing of a case in which a nozzle is attached as a separate member; and FIG. 4(c) is a drawing illustrating the configuration of the nozzle shown in FIG. 4(b).

FIG. 5 shows an example in which the diffuser pipe is bent in a wave shape, where FIG. 5(a) is a planar view, FIG. 5(b) is a front view, and FIG. 5(c) is a side view.

FIG. 6 shows an example in which the diffuser pipe is bent in a wave shape with joints, where FIG. 6(a) is a front view showing one unit; FIG. 6(b) is a front view showing a state in which multiple units are linked together; and FIG. 6(c) is a side view.

FIG. 7 is an image illustrating the results of tests which show the relationship between the depth of the diffuser pipe [where FIG. 7(a) is 100 mm; FIG. 7(b) is 300 mm; FIG. 7(c) is 500 mm; and FIG. 7(d) is 1,000 mm] and the area into which air bubbles are blown.

FIG. 8 is an image illustrating the results of tests which show the relationship between the depth of the diffuser pipe [where FIG. 8(a) is 300 mm and FIG. 8(b) is 500 mm] and the area into which air bubbles are blown.

FIG. 9 is an image illustrating the results of tests which show the relationship between the volumetric flow rate of air fed Into the diffuser pipe [where FIG. 9(a) is 80 L/min; FIG. 9(b) is 150 L/min; and FIG. 9(c) is 300 L/min] and the area into which air bubbles are blown.

FIG. 10 is a drawing illustrating an example in which the area surrounding the blow holes is covered with a net having holes with a diameter smaller than the diameter of the filtration sand.

FIG. 11 is a drawing illustrating an example in which the area surrounding the blow holes is covered with a porous member having holes with a diameter smaller than the diameter of the filtration sand, wherein FIG. 11(a) shows a state prior to attaching the porous member, and FIG. 11(b) shows a state in which a porous member is attached at a position of a blow hole.

### PREFERRED EMBODIMENT OF THE INVENTION

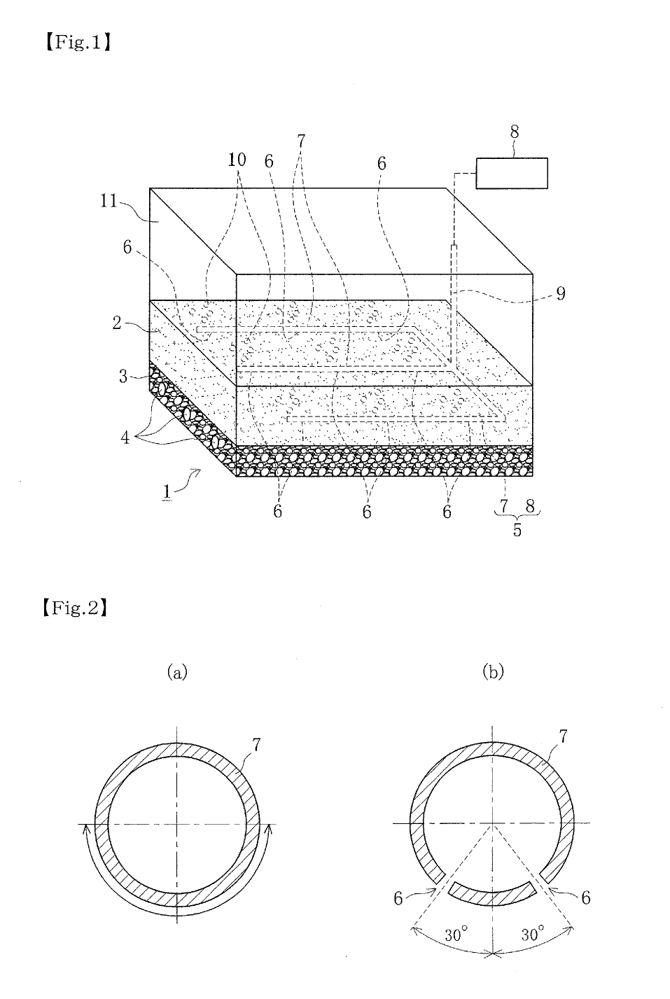

An example of a preferred embodiment of the present invention is described in detail below, using FIGS. 1-11.

### EXAMPLE

In FIG. 1, Reference Numeral 1 is an apparatus for an infiltration intake of seawater to take in a seawater which has been infiltrated through a sand filtration layer 2 and a supporting gravel layer 3 which are arranged on an ocean floor, by means of a water intake pipe 4 buried in the supporting gravel layer 3. The water intake pipe 4 is a pipe has a water intake orifice, and a water collection pump is connected to the water intake pipe 4 to take in seawater which has been infiltrated through the sand filtration layer 2 and the supporting gravel layer 3.

Reference Numeral 5 is a cleaning system of the present invention which performs cleaning by removing sediments which cause clogging of the sand filtration layer 2, and which has a diffuser pipe 7 having a blow hole 6 and is buried in the sand filtration layer 2, and a compressed air delivery device 8 which feeds an air into the diffuser pipe 7.

In the present example, a plurality of diffuser pipes 7 are buried and lined up next to each other horizontally. The diffuser pipes 7 are connected to a collecting pipe 9, and the collecting pipe 9 is connected to the compressed air delivery device 8 which includes a compressor and an air tank. In the present invention, the diffuser pipes 7 are straight pipes which have the blow holes 6 disposed at fixed intervals. Reference Numeral 10 represents air bubbles which are blown from the blow holes 6.

Because the diffuser pipes 7 are buried in the sand filtration layer 2, the present invention is able to perform cleaning by periodically feeding air into the diffuser pipes 7 from the compressed air delivery device 8, so as to agitate filtration sand in the sand filtration layer 2 by blowing the air from the blow holes 6, thus blowing upward into a seawater 11 the sediments trapped in the sand filtration layer 2 or accumulated on the surface thereof. The sediments which are blown upward into the seawater 11 are discharged to outside of the system in the water intake area by a wave or a current, for example.

FIG. 2 shows transverse sectional views of the diffuser pipe 7. It is desirable to dispose the blow holes 6 in a range of positions such that the blow holes 6 face downward from their horizontal position when installed on the ocean floor, as shown by the arrows in FIG. 2(a). This is because if the blow holes 6 are disposed in a position facing upward, filtration sand readily flows into the diffuser pipes 7 when in a stand-by mode when cleaning is not being performed. If the blow holes 6 are disposed in a position facing downward from their horizontal position, the filtration sand can be prevented from flowing in as long as the pressure within the diffuser pipes 7 is higher than outside.

In order to inhibit a reverse flow of filtration sand into the diffuser pipes 7, it is desirable for the diameter of the blow holes 6 to be of a size 5 times smaller than the average particle size of the filtration sand.

In the example shown in FIG. 1, two blow holes 6 are disposed in positions rotated ±30° right or left, using as a standard (0°) the lower end of the vertical direction in a cross-section of the diffuser pipe 7. The blow holes 6 are oriented radially from the center of the diffuser pipe 7. This configuration makes it possible to prevent the flow of sand into the diffuser pipe 7, and also to blow highly pressurized air out into a wide area even if there is one diffuser pipe 7.

The present invention may employ a perforated diffuser pipe which releases air bubbles from along the entire body of the pipe, but the type of pipe shown in FIG. 2(b) is able to expel the air at a higher pressure, as long as there is no change in the amount of air which is supplied, thereby enhancing the cleaning effect on the filtration sand in the area surrounding the blow holes 6.

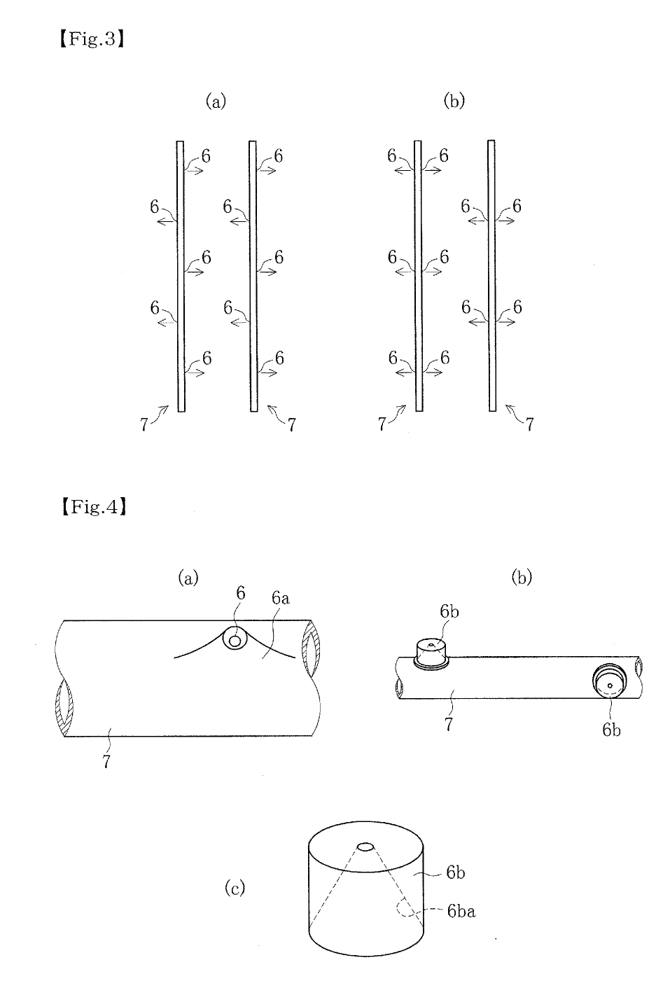

As shown in a planar view of the diffuser pipes 7 in FIG. 3, the blow holes 6 are disposed in positions which do not interfere with the blow holes 6 of another neighboring diffuser pipe 7. This enhances the over-all cleaning effect, because there is no reduction in the pressure at which the air is expelled. Specifically, a configuration is employed wherein the blow holes 6 in one diffuser pipe 7 are arranged in a staggered configuration which alternates between right and left, and the blow holes 6 are arranged in a staggered configuration so that the blow holes 6 are disposed in positions between the blow holes 6 vis-à-vis the other diffuser pipe 7, as shown in FIG. 3(a).

In another example, the blow holes 6 may be arranged in the same positions on the right and left, and disposed so that the blow holes 6 of one diffuser pipe are in a staggered position vis-à-vis the blow holes of a neighboring diffuser pipe 7, as shown in FIG. 3(b).

In the configuration of the diffuser pipe 7 shown in FIG. 2, if the internal pressure of the diffuser pipe 7 is lower than the external pressure when cleaning of the sand filtration layer 2 is completed, there is a possibility of a reverse flow of sand together with seawater into the diffuser pipe 7. In a worse-case scenario, if this reverse flow of filtration sand continues to accumulate within the diffuser pipe 7, there is a risk that the diffuser pipe 7 will become plugged.

Accordingly, it is advantageous in the present invention for the blow holes 6 to be shaped in the form of a nozzle which protrudes toward the outside of the diffuser pipe 7, because even in the event that there is a reverse flow of filtration sand into the diffuser pipe 7, it becomes easier to discharge it to the outside, during the next cleaning.

Specifically, as shown in FIG. 4(a), the blow holes 6 are shaped in the form of a nozzle by pushing out the surrounding area 6a of the blow hole 6. Also, as shown in FIG. 4(b), a nozzle 6b may be attached as a separate member to the diffuser pipe 7. The attaching position of the nozzle 6b may, for example, be in a position to rotate ±60° using as a standard (0°) the lower end of the vertical direction at the time of installation on the ocean floor.

As shown in FIG. 4(c), when nozzle 6b is used as a separate member, its external shape is cylindrical, but its internal shape has a nozzle surface 6ba which is formed in the shape of a conical frustum (a cone with the tip removed in a horizontal plane). Such a nozzle 6b may be formed from rubber or from a synthetic resin.

In order to prevent the reverse flow of filtration sand, the present invention may employ a structure in which the diffuser pipe 7 is bent in a wave shape, so that the position of the blow holes 6 is in the lowest vertical position when installed on the ocean floor.

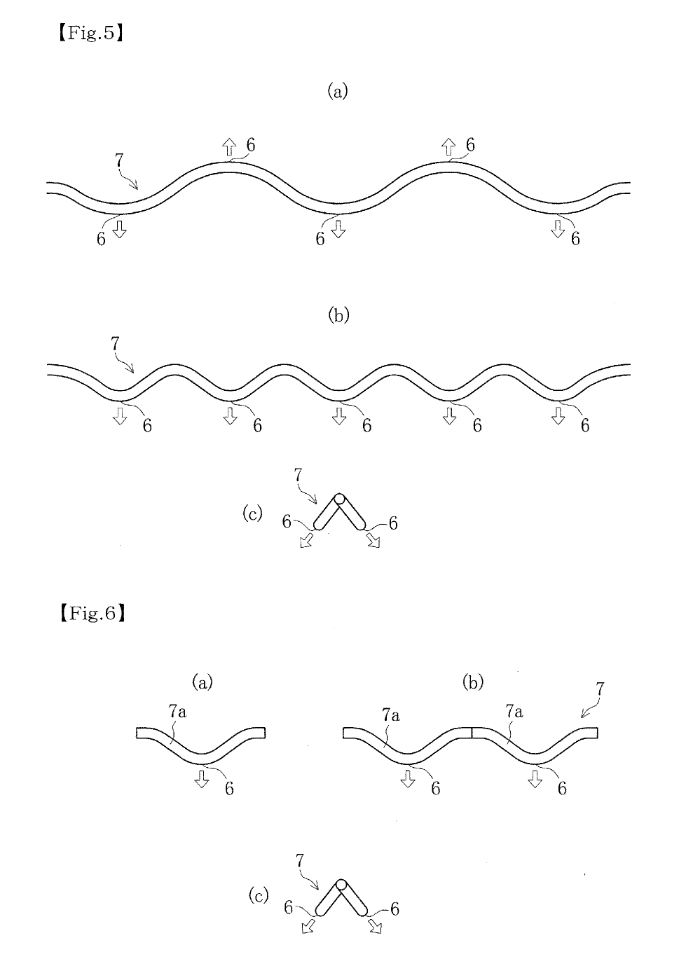

Specifically, by bending the diffuser pipe 7 into a wave shape, as shown in FIGS. 5(a)-5(c), for example, the position at which the blow holes 6 are disposed is the lowest vertical position when installed on the ocean floor. If this is done, then even if there is a reverse flow of filtration sand into the diffuser pipe 7, it is possible to easily discharge the sand to the outside during the next washing, because the filtration sand is guided toward the blow holes 7 by the inclination.

Further, as shown in FIG. 6, if the diffuser pipe 7 is bent in a wave shape, a plurality of units 7a may be connected to form a joint-type diffuser pipe. In the example shown in FIG. 6, the same effect of easily discharging the filtration to the outside that is shown in FIG. 5 is achieved by simply using a specified number of connected diffuser pipes as shown in FIG. 6(b) and FIG. 6(c) having units of the type illustrated in FIG. 6(a).

If the burying depth of the diffuser pipe 7 (the distance from the surface of the filtration sand layer 2 to the blow holes 6 of the diffuser pipe 7) is too shallow, there is a risk that the diffuser pipe 7 will become exposed in the ocean, because the air bubbles 10 are blown only directly above the blow holes 6, without being dispersed within the sand filtration layer 2, and also because the ocean floor is scoured by waves and by ship traffic. On the other hand, if the burying depth of the diffuser pipe 7 is too deep, a uniform cleaning becomes impossible, because the air bubbles 10 are not blown into the upper portion of the sand filtration layer 2 in the ocean, due to greater resistance of the sand filtration layer 2, and this results in air being trapped within the sand filtration layer 2.

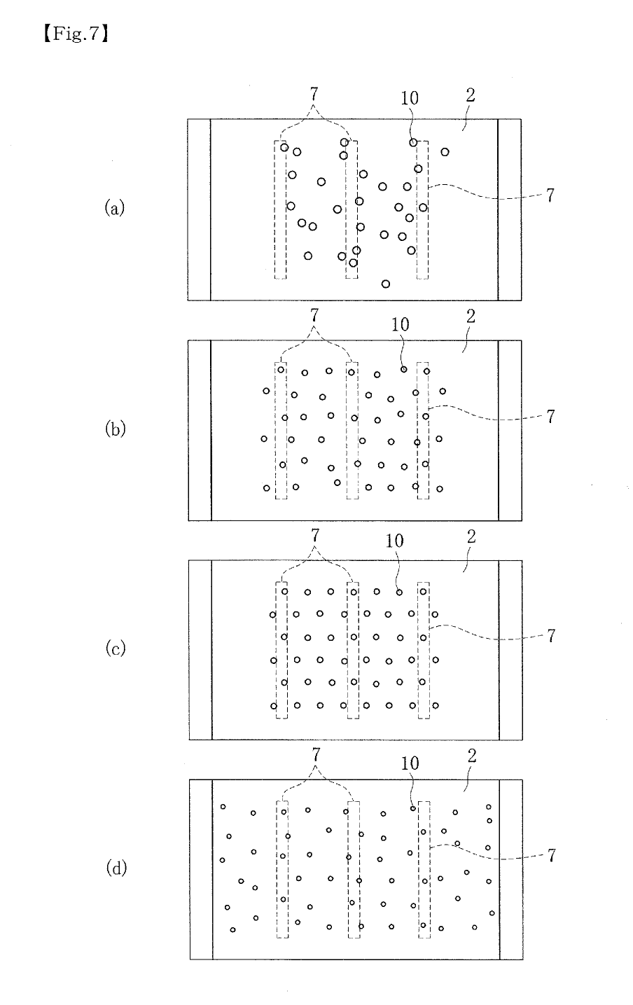

Accordingly, the present inventors conducted experiments to determine the area into which air bubbles 10 are blown, in which a group of diffuser pipes (blow hole diameter of 2 mm, blow hole attachment angle of 30°, blow hole pitch of 300 mm, and distance between diffuser pipes of 300 mm) is installed at burying depths of 100 mm, 500 mm, and 1,000 mm. FIG. 7 shows the results of these tests, with an image of the sand filtration layer 2 viewed from a planar orientation.

If the burying depth is 100 mm (See FIG. 7(a)), the depth is too shallow, so the distance at which air is blown from the blow holes 6 is insufficient, resulting in the air bubbles 10 blowing mainly only above the blow holes 6, with the air bubbles 10 also being large in size. Accordingly, there is an area in which the air bubbles 10 are not blown between the diffuser pipes 7, making it impossible to evenly clean within the cleaning area.

If the burying depth is 300 mm (see FIG. 7(b)), the area within which the air bubbles 10 are blown tends to make it slightly difficult to diffuse the air bubbles, and it tends to readily blow large air bubbles above the blow holes 6, as compared with a burying depth of 500 mm, as described below, but it was found that the air bubbles are evenly blown within the general area in which the diffuser pipes 7 are installed.

It was determined that if the burying depth is 500 mm (see FIG. 7(c)), the air bubbles 10 are most uniformly blown in the area in which the diffuser pipes 7 are installed.

If the burying depth is 1,000 mm (see FIG. 7(d)), resistance increases because the sand filtration layer 2 is thicker, and the air bubbles 10 are readily blown from the vicinity of a wall and a group of pipes which are outside of the area within which the diffuser pipes 7 are installed, making it impossible to evenly clean the area within which the diffuser pipes 7 are installed.

TABLE 1 summarizes the results of the tests described above, as well as the results for burying depths of 200 mm and 700 mm, and evaluates these results. Evaluation is recorded in 5 levels, with a score of “5” as the best, and a score of “1” as the worst.

TABLE 1

| Burying Depth | State of Bubbles | Score |
|---|---|---|
| 100 mm | Bubbles appear directly above the blow holes, so there is an area | 1 |
| | into which air bubbles are not blown between the diffuser pipes. It | |
| | is not possible to uniformly clean within the cleaning area. | |
| 200 mm | The results are not as favorable as for a burying depth of 300-500 mm, | 3 |
| | but bubbles are blown into the area where diffuser pipes are | |
| | installed, this making them usable for cleaning. | |
| 300 mm | Bubbles were determined to be roughly uniformly blown into the | 4 |
| | area where diffuser pipes are installed. | |
| 500 mm | Bubbles were determined to be most uniformly blown into the area | 5 |
| | where diffuser pipes are installed. | |
| 700 mm | The results are not as favorable as for a burying depth of 300-500 mm, | 3 |
| | but bubbles are blown into the area where diffuser pipes are | |
| | installed, this making them usable for cleaning. | |
| 1,000 mm | Bubbles are blown outside of the area where the diffuser pipes are | 1 |
| | installed. It is impossible to uniformly clean in the area where | |
| | diffuser pipes are installed. | |

TABLE 1 shows that it is advantageous when the burying depth of the diffuser pipe 7 ranges from 200 mm to 700 mm, for a score of “3” or higher, and that is more advantageous when the burying depth of the diffuser pipe 7 ranges from 300 mm to 500 mm, for a score of “4” or higher.

Following is a description of the interval between the diffuser pipes 7. If a plurality of diffuser pipes 7 are buried and lined up next to each other horizontally, as in the example described in FIG. 1, the interval between the diffuser pipes 7 is advantageously in a range of 100-600 mm.

If the diffuser pipes 7 are arranged too closely together, the diffuser pipes 7 impede the infiltration of seawater, so there is a problem of a reduction in the water intake ratio. Conversely, if the diffuser pipes 7 are arranged too far apart from each other, there is a problem in that the air bubbles are not blown uniformly into the sand filtration layer 2. Studies conducted by the present inventors show that a suitable range for the interval between the diffuser pipes 7 is 100-600 mm, a range within which the above-mentioned problems do not occur.

Following is a description of the pitch at which the blow holes 6 are disposed. If a plurality of blow holes 6 are arranged in a single diffuser pipe 7, as in the example described in FIG. 1, the pitch at which the blow holes 6 are disposed is advantageously in a range of 100-700 mm.

If the pitch at which the blow holes 6 are disposed is too small, a greater volume of compressed air must be fed from the compressed air delivery device 8. Conversely, if the pitch at which the blow holes 6 are disposed is too great, the cleaning area becomes sparse. Studies conducted by the present inventors show that a suitable range for the interval between the diffuser pipes 7 is in a range of 100-700 mm, a range within which the above-mentioned problems do not occur.

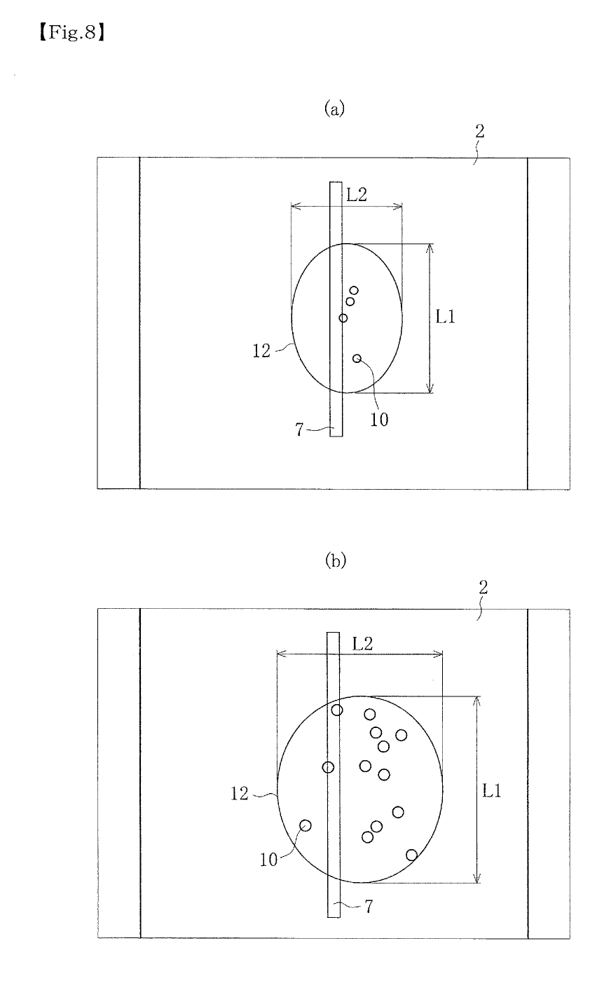

In addition, the present inventors conducted experiments to determine the area in which air bubbles are blown per blow hole, in cases where groups of diffuser pipes (blow hole diameter of 2 mm, blow hole attachment angle of 30°, and volumetric flow rate of air of 10 L/min per hole) are disposed at a burying depth of 300 mm and 500 mm. FIG. 8 shows the results of these experiments.

The results of the above experiments showed that in the case of any depth, as the volume of air fed into the diffuser pipes 7 increased, an area 12, within which the air bubbles 10 were blown from the blow holes 6, increased, so that ultimately, the axial direction of the diffuser pipe 7 formed a major axis of an ellipse.

It is thought that the reason why the area 12, within which the air bubbles 10 were blown from the blow holes 6, forms an ellipse, is that the porosity of the sand filtration layer 2 is high in the vicinity of the diffuser pipes 7, so the air bubbles readily migrate, and the air bubbles 10 adhere to the diffuser pipes 7, and move along the axial direction of the diffuser pipes 7.

If the burying depth is 300 mm (see FIG. 8(a)), the size of the elliptical area 12 into which the bubbles 10 are blown, has a length of the major axis L1 which is 35-40 cm, and a length of the minor axis L2 which is 25-30 cm. On the other hand, if the burying depth is 500 mm (see FIG. 8(b)), the length of the major axis L1 is 40-45 cm and the length of the minor axis is 30-35 cm.

According to the experiments conducted by the present inventors, it was determined that the area into which the air bubbles 10 are blown from one blow hole 6 also depends on the burying depth of the diffuser pipes 7. This is thought to be because the deeper the burial depth of the diffuser pipes 7, the wider the area into which the air bubbles 10 diffuse until reaching the surface of the sand filtration layer 2.

Based on the above findings, it is advantageous for the interval between the diffuser pipes to range from 100 mm to 300 mm if the burying depth of the diffuser pipes 7 ranges from 100 mm to 300 mm.

Furthermore, if the burying depth of the diffuser pipes 7 ranges from 100 mm to 300 mm, the pitch at which the blow holes 6 are disposed is advantageously in a range of 150-500 mm.

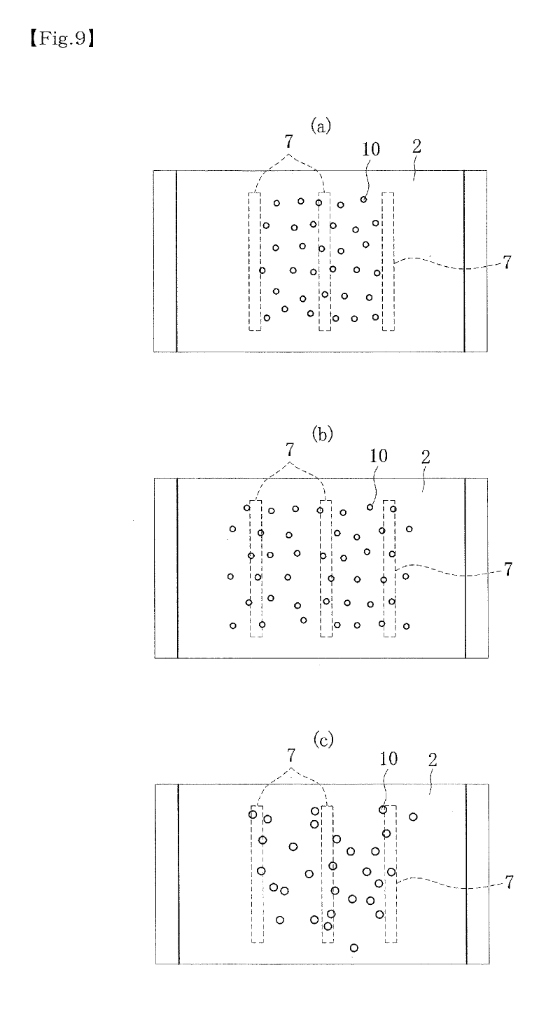

Moreover, the present inventors conducted experiments to determine the relationship between the volumetric flow rate of air fed into the group of diffuser pipes (blow hole diameter of 2 mm, blow hole attachment angle of 30°, blow hole pitch of 300 mm, distance between diffuser pipes of 300 mm, and burying depth of 500 mm), and the area into which the air bubbles are blown. FIG. 9(a) to FIG. 9(c) show the results of tests conducted under conditions where the volumetric flow rate of air was 80 L/min, 150 L/min, and 300 L/min, and the images are viewed from a planar orientation.

It was determined that as the volumetric flow rate of air increases, the area into which the air bubbles 10 are blown gradually increases, until the volumetric flow of air fed into the diffuser pipes 7 reaches 150 L/min (10 L/min per blow hole).

It was determined that the air bubbles are evenly diffused into the area in which the diffuser pipes 7 are installed, when the volumetric flow rate of air fed into the diffuser pipes 7 is in a range of 150-200 L/min (10-13 L/min per blow hole).

It was determined that the diameter of the bubbles 10 which are blown increases, if the volumetric flow rate of air fed into the diffuser pipes 7 exceeds 200 L/min (13 L/min per blow hole). If the diameter of the air bubbles 10 increases, there is a risk that filtration sand will more readily be blown upwards with the air bubbles 10, causing the filtration sand to flow out.

Based on the above findings, it is advantageous for the volumetric flow rate of air fed from the compressed air delivery device 8 into the diffuser pipes 7 to be 10-13 L/min per blow hole under the above-mentioned conditions (blow hole diameter of 2 mm, blow hole attachment angle of 30°, blow hole pitch of 300 mm, and distance between diffuser pipes of 300 mm, and burying depth of 500 mm). However, it is predicted that the range of the volumetric flow rate will fluctuate if the blow hole pitch and the interval between diffuser pipes changes with the other conditions. Accordingly, the volumetric flow rate advantageously ranges from 2 L/min to 30 L/min.

Because the present invention, as described above, uses compressed air as a fluid which operates on the filtration sand, it can achieve a smaller size, a smaller scale of construction, and a lower running cost than a conventional system which injects fresh water or seawater into the sand filtration layer. In addition, the present invention is able to reliably prevent clogging of the sand filtration layer by regularly feeding air from the compressed air delivery device into the diffuser pipe.

The present invention is not limited to the above-described example, and the preferred embodiment may, of course, be advantageously modified within the scope of the technical ideas recited in the claims.

For example, in the above-described example, there was disclosed an example in which sediments blown upward from the sand filtration layer are discharged to outside of the system of the water intake area by waves or currents when air is fed from the compressed air delivery device 8 to perform reverse cleaning of the sand filtration layer, but the means for removing the sediments are not limited thereto. For example, a configuration may be employed in which a suction pipe connected to a suction pump is installed above the sand filtration layer 2, and the sediments which are blown upward from the sand filtration layer are suctioned by the suction pipe.

Moreover, in the above-described example, there was disclosed a configuration employed to prevent the reverse flow of filtration sand from the blow holes into the diffuser pipes, and in which the blow holes are disposed only in a range facing downward from the horizontal direction when installed on the ocean floor, and a configuration in which the blow holes themselves are formed in the shape of nozzles (see FIG. 4(a)), as well as a configuration in which nozzles are attached to the blow holes as separate members (see FIG. 4(b)), but the means for preventing the reverse flow of filtration sand are not limited thereto.

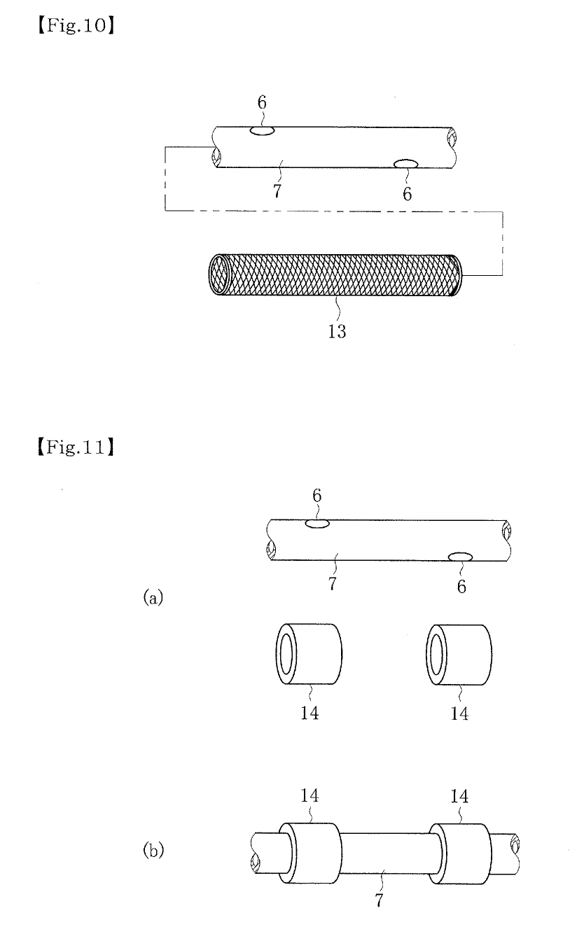

For example, as shown in FIG. 10, the reverse flow of filtration sand may be prevented by covering the diffuser pipe 7 with a net 13 having holes smaller than the diameter of the filtration sand. In the alternative, the reverse flow of filtration sand may be prevented by attaching a ring-shaped porous member 14 with holes smaller than the diameter of the filtration sand, at the position of the blow holes 6 of the diffuser pipe 7, as shown in FIG. 11.

When any of the above configurations is used, there is no longer a need to limit the range of disposition of the blow holes 6 to a side which is lower than the horizontal direction, because even if the blow holes 6 are disposed in any position on the entire circumference of the diffuser pipe 7, it is still possible to prevent the reverse flow of filtration sand. It should be noted that although FIG. 10 shows an example in which the net 13 is attached around the entirety of the diffuser pipe 7, the net 13 may be attached only at positions in which the blow holes 6 are present, as in the example illustrated in FIG. 11.

### EXPLANATION OF THE REFERENCE SYMBOLS

1 Apparatus for an infiltration intake of seawater

2 Sand filtration layer

3 Supporting gravel layer

4 Water intake pipe

5 Cleaning system

6 Blow hole

7 Diffuser pipe

8 Compressed air delivery device

1. A cleaning system used with an apparatus for an infiltration intake of seawater which performs a seawater intake, by means of a water intake pipe buried in a supporting gravel layer, after the seawater has been infiltrated through the sand filtration layer and the supporting gravel layer on an ocean floor, the cleaning system being configured to remove clogging sediments from the sand filtration layer and clean the sand filtration layer, the cleaning system comprising:
a diffuser pipe buried in the supporting gravel layer, the diffuser pipe having blow holes; and
a compressed air delivery device configured to feed an air into the diffuser pipe,
wherein the air is blown from the blow holes to agitate the filtration sand of the sand filtration layer, to remove the sediments which have become trapped in or accumulated on the sand filtration layer.

2. The cleaning system according to claim 1, wherein a burying depth of the diffuser pipe is in a range from 200 mm to 700 mm.

3. The cleaning system according to claim 1, wherein a plurality of diffuser pipes are buried at an interval in a range from 100 mm to 600 mm.

4. The cleaning system according to claim 1, wherein a pitch at which the blow holes are disposed is in a range from 100 mm to 700 mm.

5. The cleaning system according to claim 1, wherein the blow holes are disposed in a range of positions such that the blow holes face downward from their horizontal position when installed on the ocean floor.

6. The cleaning system according to claim 1, wherein a diameter of the blow holes is of a size 5 times smaller than the average particle size of the filtration sand.

7. The cleaning system according to claim 1, wherein the blow holes are disposed in positions which do not interfere with the blow holes of another neighboring diffuser pipe.

8. The cleaning system according to claim 1, wherein the blow holes are shaped in a form of a nozzle which protrudes toward the outside of the diffuser pipe.

9. The cleaning system according to claim 1, wherein the diffuser pipe is bent in a wave shape, so that the position of the blow holes is in the lowest vertical position when installed on the ocean floor.

10. The cleaning system according to claim 2, wherein a volumetric flow rate of air fed from the compressed air delivery device into the diffuser pipe is in a range from 2 L/min to 30 L/min per blow hole.
